(19) United States
(12) Patent Application Publication
(10) Pub. No.: US 2004/0137139 A1
(43) Pub. Date: Jul. 15, 2004

(54) Combined liquid candy and hard candy

(76) Inventors: Sidney Diamond, Barrington Hills, IL (US); David P. Lisowski, Schaumburg, IL (US); David M. Jupp, Chicago, IL (US); Raymond P. Cioni, Elmhurst, IL (US)

Correspondence Address: GREENBERG TRAURIG, P.C., Suite 2500, 77 West Wacker Drive, Chicago, IL, 60601, US

(21) Appl. No.: 10/341,117

(22) Filed: Jan. 13, 2003

(51) Int. Cl. A23B 4/00

(52) U.S. Cl. 426/660

(57) ABSTRACT

A novelty confectionary device with a fluid candy stored in a container and sealed by a foil membrane. Atop the container is a cap which has an access tube that supports a piece of hard candy. A straw is insertable into the access tube and through the foil membrane to provide access to the fluid candy for consumption. A clear plastic lid fits over the hard candy for minimizing contamination prior to consumption.

### BACKGROUND OF THE INVENTION

1. Field of the Invention

This invention relates generally to confectionaries and confectionary devices, and more particularly to novelty confectionary devices having both liquid and solid confectioneries.

2. Background Art

Confectionaries, particularly hard candies, have long been popular with both children and adults. More recently, fluid candies have gained in popularity. Such candies often consist of an aqueous solution of artificial flavoring and sugar. These liquid candies are generally formulated to be somewhat viscous at room temperature. Other fluid candies are powdered or finely granulated so that they flow much like a liquid. Both of these fluid candies are often “sticky” to the touch and difficult to handle. Accordingly, manufacturers of such candies must package the fluid candy in a suitable device or dispenser for consumption.

One such device which currently exists in the art is the Squeeze Pop® “Sports Bottle” candy dispenser manufactured by the Amurol Confections Company. The “Sports Bottle” dispenser comprises a cylindrical bottle containing liquid candy having an integrated, tapered dispensing tube with an inner plastic seal and a screw-on cap. In order to consume the liquid candy, a child must first unscrew the cap and then remove the plastic seal from the neck of the bottle, or puncture it. The child then must replace the cap and may proceed to consume the viscous contents of the dispenser through the dispensing tube. A child may well have difficulty either opening the cap or removing or puncturing the plastic seal without spilling any of the liquid candy inside. First, puncturing the plastic seal usually requires some sort of implement, which is not provided, and which invariably becomes sodden with the viscous fluid after it breaches the seal. Second, the act of puncturing the seal often causes a jerking motion of the hand which in turn may cause some of the viscous liquid candy to spill out of the bottle before the cap is replaced. As a result, the outside of the dispenser quickly becomes “sticky” and difficult to handle.

Another liquid candy dispenser existing in the art is the “Fr-ooze Pop” candy manufactured by Au-some Candies. As with the “Sports Bottle” candy, the “Fr-ooze Pop” candy also comprises a bottle having a screw-on cap with an integrated dispensing tube. The “Fr-ooze Pop” candy, however, does not make use of a membrane to seal the bottle. Rather, the “Fr-ooze Pop” candy cap includes a valve having a closed configuration and an open configuration. In its closed configuration, the valve prevents the liquid candy from communicating with the outside air. When the valve is in its open position, the liquid candy may be dispensed through the dispensing tube. The valve is moved into its open configuration by pulling the two ends of the “Fr-ooze Pop” candy away from each other. Conversely, the valve is moved into its closed configuration by compressing the ends of the “Fr-ooze Pop” candy towards each other. The operation of the valve is not readily apparent and, as a result, a child may have difficulty appreciating the necessity of operating the valve. A child may give up before being able to dispense the liquid candy if the child is not able to perceive how to open the valve. Or the child may not understand how to close the valve, resulting in spilling or leakage of the liquid candy before it has been fully consumed.

The “Fr-ooze Pop” candy cap also includes a hard candy coating surrounding, and sealing, the integrated dispensing tube. Thus, a child must first lick at least some of the hard candy away in order to consume the liquid candy from the bottle. While a child may prefer to consume the liquid candy first, before consuming the hard candy, the “Fr-ooze Pop” candy does not afford such an option. Furthermore, if enough of the hard candy enters the integrated dispensing tube during manufacture, a child may find it impossible to get the hard candy out of the tube.

### SUMMARY OF THE INVENTION

It is an object of the present invention to provide a novelty confectionary device providing both liquid and hard candy in a clean, sanitary, and efficient manner. It is further an object of the present invention to provide a novelty confectionary device which is intuitive and simple enough for a child to operate yet prevents the fluid inside of the dispenser from spilling or leaking.

Thus, the present invention is concerned with providing a novelty confectionary device comprising in combination a container having an upper end and a bottom end, a fluid impervious sidewall extending between the upper end and the bottom end, and a fluid impervious bottom substantially adjacent the bottom end; an amount of fluid candy in the container; a cap having a generally fluid impervious top, except for an access opening extending through the top, and a sidewall depending from the top with the depending sidewall configured to operably engage the sidewall of the container; a piece of hard candy having an upper surface and a lower surface; the piece of hard candy being positioned upon the cap with the lower surface of the hard candy on the top of the cap; a channel extending into the hard candy from the upper surface and configured to be in fluid communication with the access opening; a fluid impervious membrane positioned between the access opening and the fluid candy; and a straw for inserting into the channel and through the access opening, for puncturing the membrane, and for permitting the fluid candy to be consumed.

### BRIEF DESCRIPTION OF THE DRAWINGS

For a better understanding of the present invention, reference may be had to the accompanying drawings in which:

FIG. 1 is a perspective view of an embodiment of the novelty confectionary device;

FIG. 2 is an exploded perspective view of the novelty confectionary device;

FIG. 3 is a generally vertical cross-sectional view of the novelty confectionary device taken along line 3-3 in FIG. 1;

FIG. 4 is another generally vertical cross-sectional view, similar to that of FIG. 2 but having the lid removed and a straw inserted; and

FIG. 5 is a generally vertical cross-sectional view of an alternate embodiment of a novelty confectionary device.

FIG. 6 is a generally vertical cross-section of another alternate embodiment of a novelty confection device.

### DETAILED DESCRIPTION

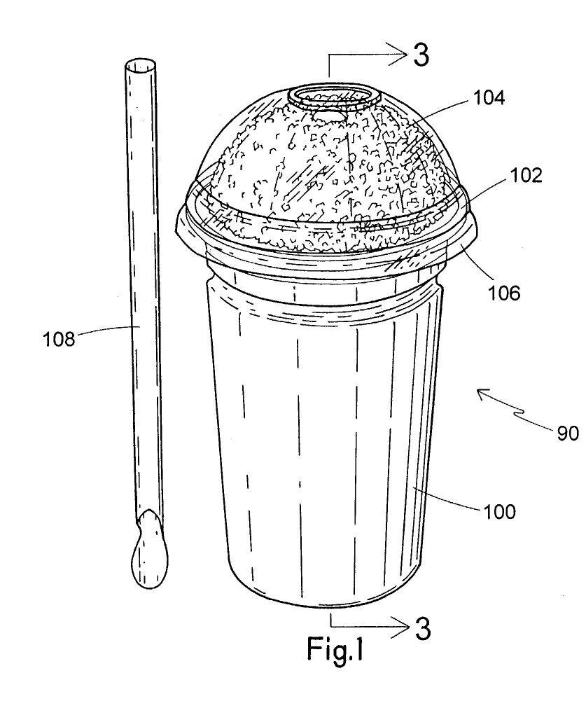

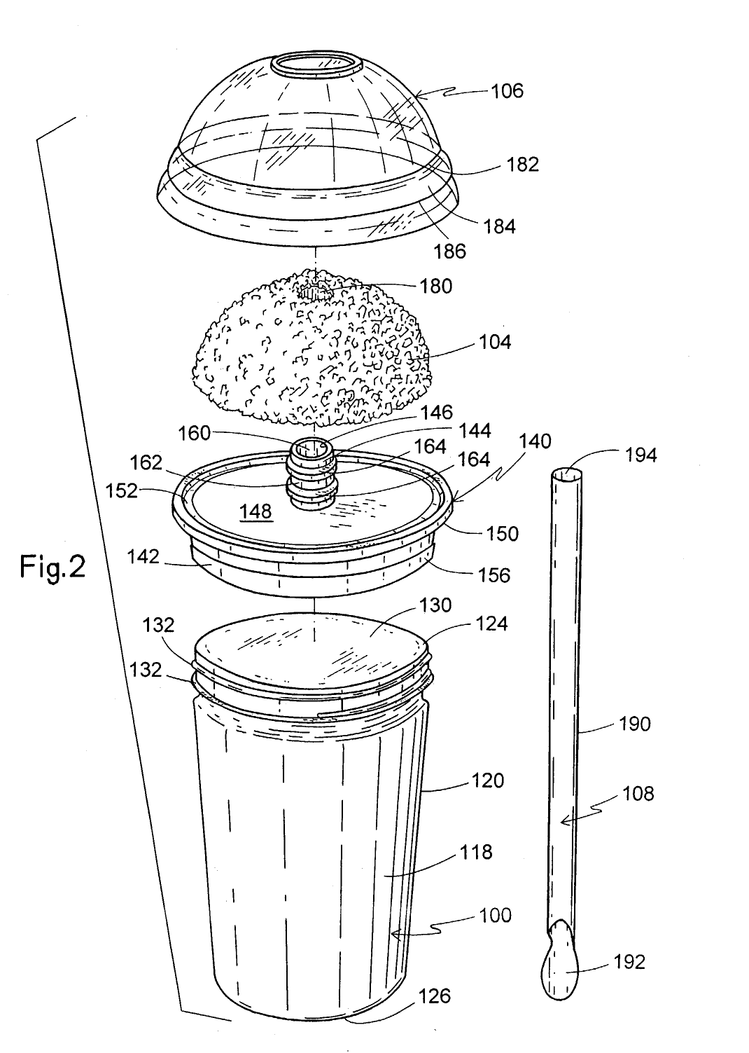

Referring now to the drawings in which like parts are designated by like reference numerals throughout the several views, there is shown in FIG. 1 a novelty confectionary device 90 having a container or cup 100, a cap 102, a piece of hard candy 104, a lid 106 and a straw 108. A fluid candy 101 is contained in cup 100. In the context of this application, “fluid” is not being used in its usual meaning of a liquid or a gas, but rather to mean either a liquid or a powdered or finely granulated solid which wheel can flow. Cap 102 is screwed onto the top of cup 100 by engaging respective threads 158 and 132, and provides a base for hard candy 104 and lid 106. Straw 108 may be attached to the outside of cup 100 in any suitable manner such as by an elastic band, an adhesive, plastic shrink wrapping, or other packaging material. Each of these components is shown in more detail in FIG. 2.

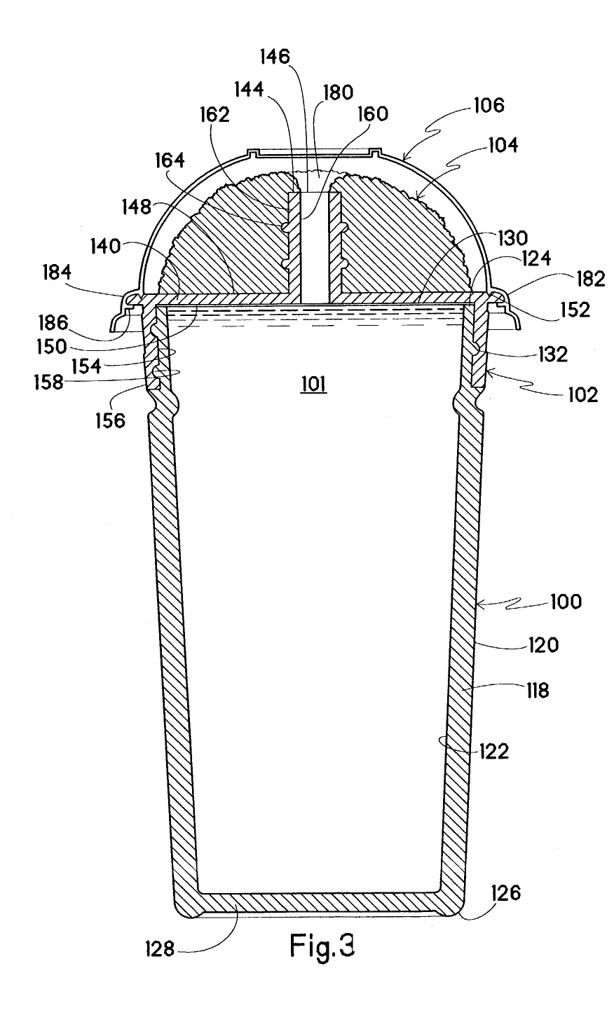

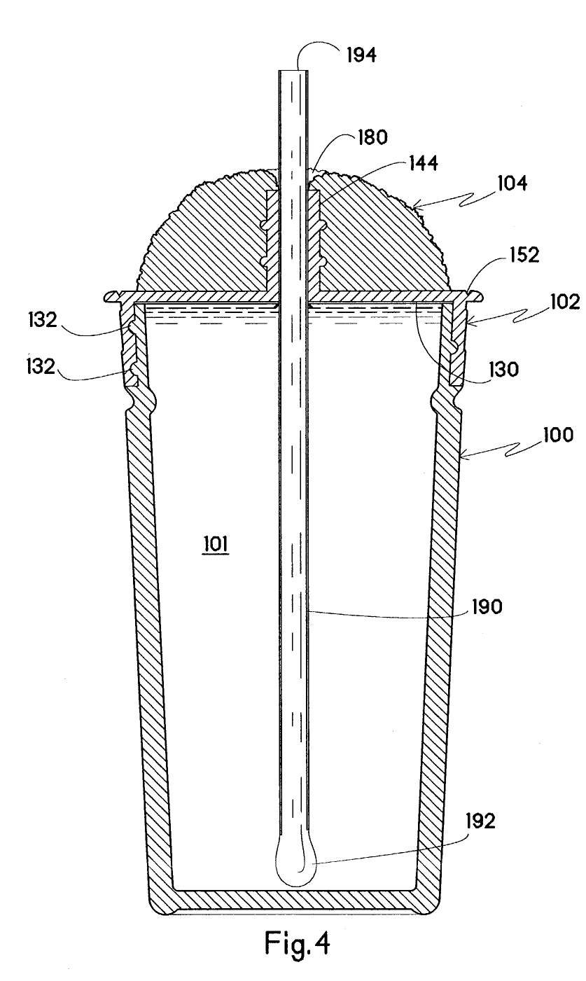

FIG. 2 illustrates container 100, cap 102, hard candy 104, lid 106 and straw 108 in exploded fashion. Cup 100 comprises a fluid impervious continuous sidewall 118 formed in a substantially tubular shape. Continuous sidewall 118 has an outer surface 120, an inner surface 122, an upper end 124 and a bottom end 126. Bottom end 126 is adjacent and substantially coplanar with a fluid impervious bottom 128. Likewise, upper end 124 (shown in FIGS. 3 and 4) is adjacent to and substantially coplanar with a fluid impervious foil membrane 130 that may be readily punctured by straw 108. Outer surface 120 of continuous sidewall 118 additionally comprises threads 132 integrally formed near upper end 124. An amount of fluid candy, such as a sweet flavored liquid 101 may be put in the interior region of cup 100 up to a predetermined level. However, as can be appreciated by those skilled in the art, any substance which may be consumed through a straw or poured out through a small dispensing tube, so as to be fluid, could be placed inside of cup 100. For example, flavored sugar particles may alternatively be placed inside of cup 100. Those skilled in the art will also recognize that the membrane may be constructed of other materials, such as plastic or composite fluid impervious materials. Furthermore, those skilled in the art will recognize that membrane 130 does not have to be disposed across the top of cup 100. Rather, foil membrane can be disposed in a fluid sealing portion any where between the fluid candy and the open tip 146 of tube 144.

Cap 102, also shown in FIG. 2, comprises circular disc 140, depending sidewall 142 and access tube 144 having an open tip 146. Disc 140 has an upper surface 148, a lower surface 150, and a lid sealing receiving groove 152.

Sidewall 142 is a continuous annular ring depending from lower surface 150 of disc 140 in a concentric manner. Depending sidewall 142 has an inner surface 154 and an outer surface 156. Inner surface 154 of depending sidewall 142 has thread grooves 158 for engaging projecting threads 132 on outer surface 120 of cup 100 to secure cap 102 to cup 100 in a substantially fluid tight relationship, except for the opening provided by access tube 144. The outer diameter of depending sidewall 142 is less than that of circular disc 140.

Access tube 144 extends upwardly from upper surface 148 of disc 140. As with depending sidewall 142, access tube 144 comprises a continuous fluid impervious sidewall forming an annular ring or tube, having an inner surface 160 and an outer surface 162. As illustrated in FIGS. 1-4, tube 144 is concentric with circular disc 140. However, the diameters of access tube 144 are much less than that of either circular disc 140 or depending sidewall 142. Rather, the inner diameter of access tube 144 is configured so as to be just large enough to allow straw 108 to pass slidably through inner surface 160 of access tube 144. The outer diameter is configured so as to permit a sizeable piece of hard candy 104 to be placed atop upper surface 148 of disc 140 and around outer surface 162 of tube 144. Outer surface 162 of access tube 144 includes ridges 146 for retaining hard candy 104, which may be molded in place around tube 144.

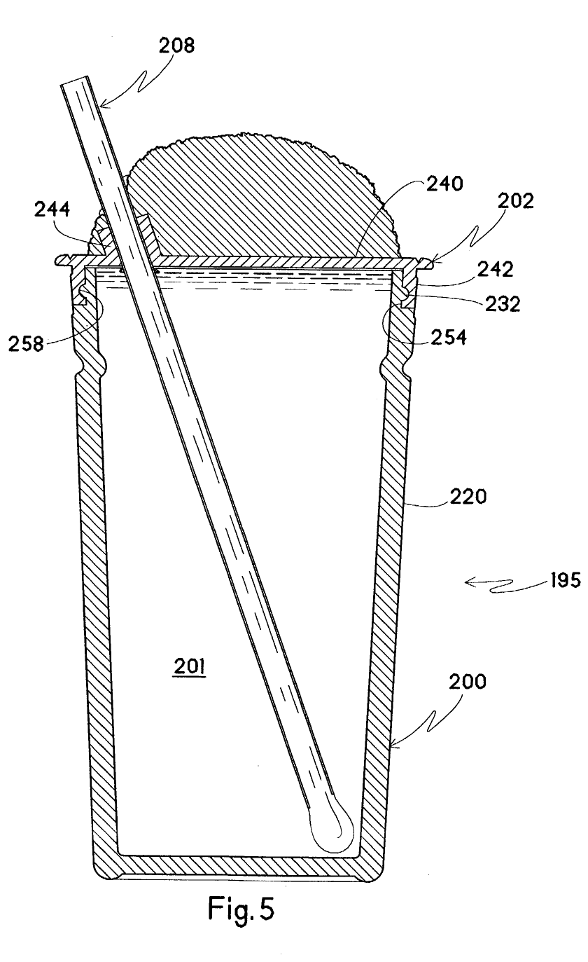

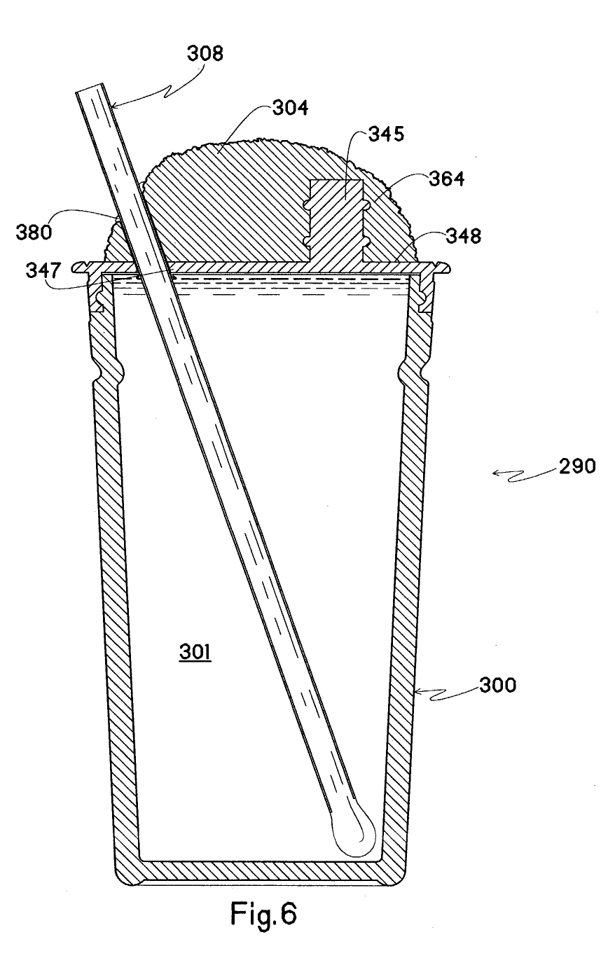

Cap 102 is screwed on to cup 100 to provide an additional seal for cup 100 and to further provide a surface on which hard candy 104 may be mounted. Of course, those skilled in the art will recognize that cap 102 is not limited to the preferred embodiment shown. For example, cap 102 could be of a snap-on construction as illustrated in FIG. 5, rather than a screw-on construction. In addition, access tube 144 does not necessarily have to be placed in the center of cap 102; rather, it could be placed off-center, and may even extend upwards at an acute angle to center disc 140, as will be described in connection with FIG. 5 below. One skilled in the art will also recognize that other anchors for retaining hard candy 104 may be included independent of any access tube. For example, cap 102 might include an entirely separate structure for retaining hard candy 104, as will be described in connection with FIG. 6. In yet another embodiment (not shown), cup 100 and cap 102 are integral with each other, and foil membrane 130 is disposed inside of, or across the top of, access tube 144. In a further embodiment (not shown), cap 102 may simply have an access hole in place of an access tube.

Hard candy 104 is disposed on top of cap 102. Hard candy 104 is preferably a hemispherical-shaped candy with a textured outer surface. However, as will be recognized by those skilled in the art, virtually any size or shape of hard candy may also be used. Hard candy 104 has a channel 180 extending from the center of the dome of the hemisphere down toward the center of the base of the hemisphere. Channel 180 is of sufficient diameter that access tube 144 will fit inside of channel 180. In one embodiment, channel 180 provides an interference fit with ridges 164. In a another embodiment, hard candy 104 is molded around access tube 144, such that hard candy 104 cannot be removed without dissolving or breaking hard candy 104.

Lid 106 is positioned over hard candy 104 and minimizes contaminants coming in contact with either hard candy 104 or access tube 144. Lid 106 comprises a clear plastic hemispherical dome having lid sealing flange 182, lid retaining groove 184, and lid retaining flange 186.

Straw 108 may comprise tubular body 190 having a lower spoon-shaped tip 192 and an opposed upper end 194. Alternatively, straw 108 may comprise tubular body 190 having an angled tip (not shown) to further facilitate puncturing membrane 130. A variety of other straws may also be used.

The cooperation of each of these components is better illustrated in FIGS. 3-4. In FIG. 3, cup 100 contains a liquid candy substance 101. Foil membrane 130 is disposed across the open top end 124 of cup 100 and seals liquid candy 101 from the outside air. Cap 102 has been screwed onto cup 100. In particular, projecting threads 132 on outer surface 120 of cup 100 cooperatively engage thread grooves 158 on inner surface 150 of cap 102. Hard candy 104 is positioned over cap 102 around access tube 144. As illustrated, hard candy 104 cooperatively engages candy support ridges 164 for holding the hard candy in place against circular disc 140.

As can be seen in FIG. 3, lid retaining flange 186 cooperates with disc 140 to retain the lid in place once it has been placed over the hard candy 104. Particularly, lid retaining flange 186 contacts bottom surface 150 of circular disc 140, prompting the edge of disc 140 to be retained in lid retaining groove 184. In addition, disc 140 includes a lid sealing groove 152 which cooperates with lid sealing flange 182 to provide a substantially airtight seal, maintaining the freshness of the hard candy 104 and minimizing contaminants from entering either hard candy 104 or the cup 100.

In operation, a child first removes straw 108 if it is secured to the cup and then lid 106, exposing hard candy 104 and access tube 144. With hard candy 104 and access tube 144 exposed, the child may consume either the hard candy or the liquid candy in any order desired. Hard candy 104, for example, may be licked or, in some embodiments, removed for consumption. When the child is ready to consume the liquid candy, straw 108 is inserted into access tube 144 and pushed against foil membrane 130 to puncture it. As illustrated in FIG. 4, the child punctures foil membrane 130 with straw 108 and can then consume fluid candy 101 through straw 108. Notably, this design prevents fluid candy 101 from splashing out of the container and decreases substantially the likelihood that any of the fluid will be spilled, while retaining the advantages of having the fluid candy sealed from contamination during shipping.

FIG. 5 illustrates another embodiment of a confectionary device 195 according to the present invention. Access tube 244 is configured at an acute angle to circular disc 240, allowing straw 208 to reach the corner of cup 200 to better “scavenge” the fluid candy contents 201 of cup 200.

FIG. 5 also illustrates a snap-on cap 202 having a depending sidewall 242 with an inner surface 254. A single circular groove is formed around inner surface 254. Adjacent its upper end, outer surface 220 of cup 200 has a single outwardly projecting circular bead 232 that cooperates with groove 258 to provide a snap-on connection for cup 202.

Likewise, FIG. 6 illustrates yet another alternate embodiment of a novelty confectionary device 290 according to the present invention. Particularly, a separate support post 345 extends from upper surface 348 of disc 340. Support post 345 comprises a solid post having candy retaining ridges 364. Channel 380 in hard candy 304 and access opening 347 serve to provide access to the interior of cup 300 and fluid candy 301 for straw 308.

While particular embodiments of the invention have been shown and described, further variations and modifications will occur to those skilled in the art. It is intended in the appended claims to cover all such variations and modifications as come within the true spirit and scope of the present invention.

What is claimed as new and desired to be secured by Letters Patent is:

1. A novelty confectionary device comprising in combination:
a container having an upper end and a bottom end, a fluid impervious sidewall extending between the upper end and the bottom end, and a fluid impervious bottom substantially adjacent the bottom end;
an amount of fluid candy in the container;
a cap having a generally fluid impervious top, except for an access opening extending through the top, and a sidewall depending from the top with the depending sidewall configured to operably engage the sidewall of the container;
a piece of hard candy having an upper surface and a lower surface;
the piece of hard candy being positioned upon the cap with the lower surface of the hard candy on the top of the cap;
a channel extending into the hard candy from the upper surface and configured to be in fluid communication with the access opening;
a fluid impervious membrane positioned between the access opening and the fluid candy; and
a straw for inserting into the channel and through the access opening, for puncturing the membrane, and for permitting the fluid candy to be consumed.

2. The novelty confectionary device of claim 1 in which the container and the cap are configured for the cap to be screwed on to the upper end of the container.

3. The novelty confectionary device of claim 1 in which the container and the cap are configured for the cap to be snapped onto the upper end of the container.

4. The novelty confectionary device of claim 1 further comprising a lid securable to the device.

5. The novelty confectionary device of claim 4 in which the lid has a lid retaining flange and a lid retaining channel that cooperatively engage the cap to secure the lid to the device.

6. The novelty confectionary device of claim 5 in which:
the lid further includes a sealing flange;
the cap further includes a sealing groove; and
the sealing flange cooperates with the sealing groove to form an airtight seal when the lid is attached to the device.

7. The novelty confectionary device of claim 6 in which:
the sealing flange is in the shape of a “V”; and
the sealing groove is in the shape of a “V”.

8. The novelty confectionary device of claim 1 in which the fluid candy is a liquid candy.

9. The novelty confectionary device of claim 1 in which the fluid candy is a powdered candy.

10. The novelty confectionary device of claim 1 in which:
an access tube extends upwardly from the top of the cap; and
an upper tip of the access tube provides the access opening.

11. The novelty confectionary device of claim 10 in which the channel in the hard candy engages the access tube.

12. The novelty confectionary device of claim 11 in which:
the access tube includes an outer surface, and a series of ridges on its outer surface; and
the hard candy is molded around the outer surface of the access tube so that the ridges on the outer surface of the access tube anchor the hard candy.

13. The novelty confectionary device of claim 1 in which the container is a cup, and the sidewall is in a generally tubular shape.

14. The novelty confectionary device of claim 1 in which the cap has a support post extending upwardly from the top for anchoring the hard candy.

15. The novelty confectionary device of claim 1 in which the membrane is positioned intermediate the fluid candy and the cap.

16. The novelty confectionary device of claim 1 in which the membrane is positioned intermediate the cap and the hard candy.

17. The novelty confectionary device of claim 1 in which the straw is attached to the outside of the container by packaging material.

18. The novelty confectionary device of claim 1 in which the straw has opposed ends and one of the ends is shaped to facilitate puncturing the membrane.
